(19) United States
(12) Patent Application Publication
(10) Pub. No.: US 2008/0167951 A1
(43) Pub. Date: Jul. 10, 2008

(54) METHOD AND SYSTEM FOR DETERMINING OFFERING COMBINATIONS IN A MULTI-PRODUCT ENVIRONMENT

(76) Inventors: Jianying HU, Bronx, NY (US); Aleksandra Mojsilovic, New York, NY (US)

Correspondence Address: Whitham, Curtis, & Christofferson, P.C., 11491 Sunset Hills Road, Suite 340, Reston, VA, 20190, US

(21) Appl. No.: 12/052,977

(22) Filed: Mar. 21, 2008

Related U.S. Application Data
(63) Continuation of application No. 11/191,081, filed on Jul. 28, 2005.

(51) Int. Cl. G06Q 10/00; G06F 17/00

(52) U.S. Cl. 705/10; 705/7

(57) ABSTRACT

A multi-product environment is analyzed to identify combinations of products or services which represent strategic offerings of a company. For a multi-product environment and a set of client accounts, a segmentation tree is constructed to identify the offering groups of interest. The tree is first initialized as a root representing all offerings, all clients and an empty offering set. A recursive algorithm is then applied to grow the tree at each node by segmenting the clients based on whether a particular offering is purchased. The selection of the offering to use for segmentation at each node is determined by a mathematical algorithm that considers two factors: 1) the offering should have high pulling power, meaning it is likely to produce high revenue in combination with other offerings, and 2) the offering should be unlikely to cause fragmentation, meaning nodes representing a very small amount of revenue. The algorithm terminates when each leaf node reaches one of the two limits: 1) Representation limit which is reached when a significant portion of revenue is accounted for by offerings in a particular grouping and 2) Significance limit which is reached when the revenue represented by a node is too small to be considered significant. At this point all leaf nodes representing significant revenue are collected as the offering groups.

### BACKGROUND OF THE INVENTION

1. Field of the Invention

The present invention generally relates to a process for assisting companies with a diverse set of products and solutions in identifying strategic offerings (e.g., combinations of products or solutions that consistently drive a significant portion of company's revenue and represent significant client base) and, more particularly, to a methodology for determining strategically important purchasing patterns within the company's client base to further guide strategic decisions about effectively positioning company's products and services as stand-alone offerings, and increasing the efficiency of the organization by further exploiting and promoting cross-selling and cross-marketing of company's products and services.

2. Background Description

Today, marketing strategies of most companies and enterprises depend on customer segmentation, i.e., in understanding characteristics and behavioral patterns of their customers. Various methodologies to gather such knowledge have been developed over the years. Customer segmentation is a process of identifying homogeneous groups within company's customer base in order to develop unique proposition matching the needs of each segment. The fundamental goal of traditional market segmentation methodologies is to identify groups, segments or clusters of customers, which, from a marketing perspective, are meaningfully different from each other in terms of purchasing habits, product preferences, likelihood to buy, motivation, loyalty to the company's products and services, or present and future value to the company.

One of the standard approaches in market segmentation is the use of data mining, statistical analysis and pattern recognition methodologies to discover different clusters and identify their discriminating characteristics. Segmentation criteria typically include demographic information, lifestyle and life-stage data, buying factors, needs, lifestyles, behavioral information, etc. Following the customer segmentation, propensity models (models comparing the attributes of prospects lists to the attributes of existing customers) are often developed by businesses and used to develop target lists of persons who look like existing customers, and therefore might have a greater propensity to respond to marketing initiatives and buy company's product or service. Therefore, customer segmentation is typically perceived as a marketing tool for customer portfolio management, product development, marketing strategy, and promotional and targeting decisions, and has not been considered as affecting the whole corporation strategically. It is typically conducted to answer the following questions, who are my most loyal clients, which segments should we target, how can we manage customer segments by allocating resources among them, who are my new most likely customers. Thus, market segmentation has been used more as a tactical device than a strategic decision support tool. Recently, a new opportunity for pattern recognition as a support tool in strategic decision making process has arisen. As more and more companies diversify their operations and expand the spectrum of their products and services, it is becoming critical to understand cross-cohesion among different products/services and identify natural groupings of products/service that were not expected to exist or have not been addressed in the development phase of each individual product. Rather than helping develop marketing strategies for a particular product, or a certain customer segment, such knowledge is far more important as it could guide strategic decisions at the top levels of corporation, optimize the behavior of the entire enterprise by exploiting the linkages between different brands, institute new offerings by “bundling” the discovered combinations of products/services, and even open up new markets and new opportunities driven by the identified relationships.

We will clarify this problem through an example of a large hardware company. Over the course of several decades, the company has developed and launched a number of different hardware products and related equipment: mainframes, super-computers, personal computers, small computing devices, storage devices, etc. As the market grew, the company grew as well and began to add a variety of software offerings and operating systems to maintain and support systems they are selling. Soon, the operating systems evolved to include more sophisticated productivity applications, relational databases, programming environments and software suits supporting various tasks on company's computers. As these products became more and more popular, the software packages evolved further and became independent on company's operating platforms, thus running on a variety of different (often competitive) systems. Naturally, the company decided to expand and in addition to the existing hardware divisions, it instituted several different software groups. As the information technology further advanced, and as systems became more and more complicated, calling for the integration of multiple platforms and applications, the company realized the value of technical support, help desk operations, maintenance, and technology consulting, and started to offer these services through a variety of newly instituted divisions. Thus, the company that was once viewed as “pure” hardware and equipment manufacturer became a conglomerate of different units, each representing and running as an individual company. Each unit had its own strategy, goals and measurements, management, marketing and sales force. However, although these individual units were designed to run independently and serve their customer base, the company management soon realized that some of the seemingly unrelated products are often purchased together. So the question quickly became, in such a diverse multi-product environment, is it possible to segment the space of products and services and determine the combinations, which are tend to be bought together, and which represent significant components of the total company earnings? Companies could benefit enormously from identifying cross-cohesion in such a diverse multi-product environments. They could eliminate organizational inconsistencies, optimize their marketing and sales efforts, institute new offerings and influence the strategic directions of the corporation. Our hardware company is just one example of something that is becoming a trend in today's market place. This kind of diverse behavior is representative for large corporations across all economic sectors, for example, it is often seen in banks and financial services organizations, insurance, even manufacturing.

Note that the described segmentation problem is very different in nature from the traditional market segmentation or shopping-basket analysis techniques, which attempt to identify items that are frequently bought together. These traditional approaches apply data-mining, statistical analysis and pattern recognition to detect most frequent combinations of purchases by analyzing millions and millions of transactions in a data warehouse. In our case of product/services analyses, we are looking into a customer base of a single company (thus a far smaller data set will be analyzed) and many of the traditional approaches cannot be applied. Furthermore, rather then mining for the most frequent combinations of purchases, companies are interested in the combinations that have the most significant impact on the bottom-line revenue. Finally, companies are also looking to identify products and services that are likely to drive the purchase of additional products and services sometime in the future, a problem that also cannot be addressed by standard shopping basket analysis. This problem is also very different in nature from the current segmentation methodologies, as they focus on a client portfolio and its value to the organization. Therefore, when applied to segment company's products and services these methodologies produce sub-optimal results. Hence, it is very important to develop an approach for segmenting company's individual products/services in order to identify the important cross-cohesion drivers in overall performance.

### SUMMARY OF THE INVENTION

It is therefore an object of the present invention to provide a process or methodology for analyzing a multi-product environment and identify the combinations of products/services, which represent strategic offerings of a company. One example of strategic offerings are combinations of products/services, which represent significant amount of company's total revenue and span a considerable portion of its client base.

According to the invention, for a multi-product environment and a set of client accounts, a segmentation tree is constructed to identify the offering groups of interest. The tree is first initialized as a root representing all offerings, all clients and an empty offering set. A recursive algorithm is then applied to grow the tree at each node by segmenting the clients based on whether a particular offering is purchased. The selection of the offering to use for segmentation at each node is determined by a mathematical algorithm that considers two factors: 1) the offering should have high pulling power, meaning it is likely to produce high revenue in combination with other offerings, and 2) the offering should be unlikely to cause fragmentation, meaning nodes representing a very small amount of revenue. The algorithm terminates when each leaf node reaches one of the two limits: 1) Representation limit which is reached when a significant portion of revenue is accounted for by offerings in a particular grouping and 2) Significance limit which is reached when the revenue represented by a node is too small to be considered significant. At this point all leaf nodes representing significant revenue are collected as the offering groups.

Compared to previous methods such as market basket analysis, this algorithm has the advantage that it is able to identify groups of offerings where the offerings in each group not only occur together often, but more importantly contribute a significant amount of revenue. Furthermore, all the offering groups taken together span a significant portion of the client base.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a block diagram of a computer system on which the method according to the invention may be implemented;

FIG. 2 is a block diagram of a server used in the computer system shown in FIG. 1;

FIG. 3 is a block diagram of a client used in the computer system shown in FIG. 1;

FIG. 4 is a flow diagram showing the overall logic of the method according to the invention;

FIG. 5 is a flow diagram showing the logic of the children generating procedure used in the method illustrated in FIG. 4;

FIG. 6 is a flow diagram showing the logic of the computation of the “pulling factor” of an offering at a particular node in the method illustrated in FIG. 4; and

FIG. 7 is a flow diagram showing the logic of the computation of the “fragmentation factor” of an offering at a particular node in the method illustrated in FIG. 4.

### DETAILED DESCRIPTION OF A PREFERRED EMBODIMENT OF THE INVENTION

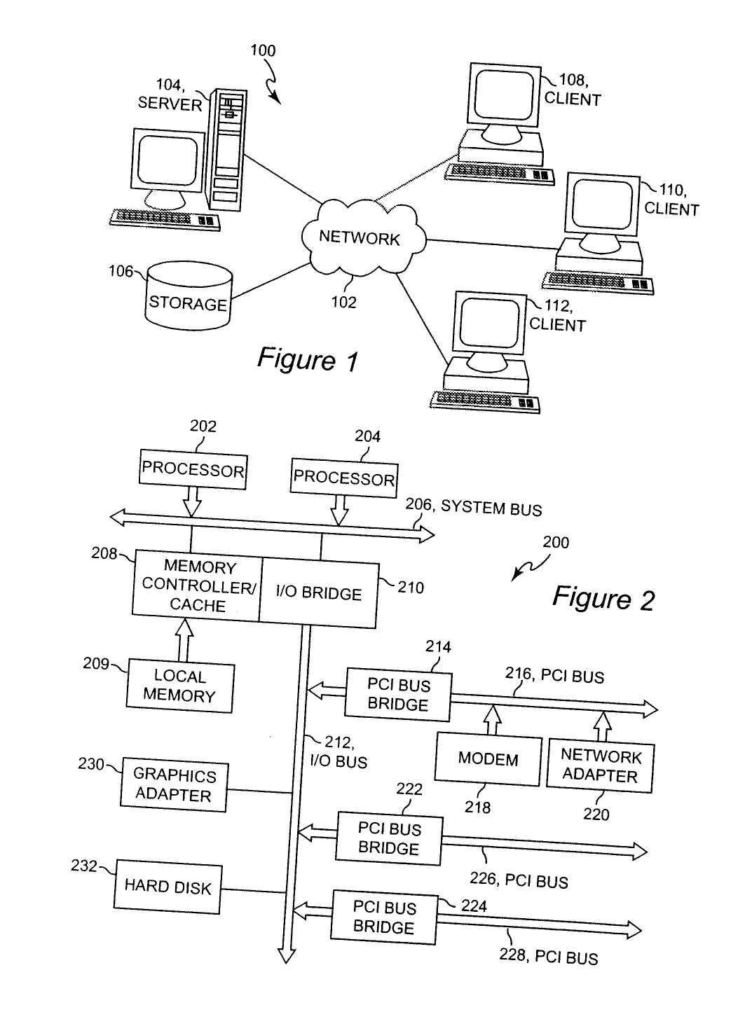

Referring now to the drawings, and more particularly to FIG. 1, there is shown a computer system on which the method according to the invention may be implemented. Computer system 100 contains a network 102, which is the medium used to provide communications links between various devices and computers connected together within computer system 100. Network 102 may include permanent connections, such as wire or fiber optic cables, wireless connections, such as wireless Local Area Network (WLAN) products based on the IEEE 802.11 specification (also known as Wi-Fi), and/or temporary connections made through telephone, cable or satellite connections, and may include a Wide Area Network (WAN) and/or a global network, such as the Internet. A server 104 is connected to network 102 along with storage unit 106. In addition, clients 108, 110 and 112 also are connected to network 102. These clients 108, 110 and 112 may be, for example, personal computers or network computers. For purposes of this application, a network computer is any computer, coupled to a network, which receives a program or other application from another computer coupled to the network. The server 104 provides data, such as boot files, operating system images, and applications to clients 108, 110 and 112. Clients 108, 110 and 112 are clients to server 104.

Computer system 100 may include additional servers, clients, and other devices not shown. In the depicted example, the Internet provides the network 102 connection to a worldwide collection of networks and gateways that use the TCP/IP (Transmission Control Protocol/Internet Protocol) suite of protocols to communicate with one another. At the heart of the Internet is a backbone of high-speed data communication lines between major nodes or host computers, consisting of thousands of commercial, government, educational and other computer systems that route data and messages. In this type of network, hypertext mark-up language (HTML) documents and applets are used to exchange information and facilitate commercial transactions. Hypertext transfer protocol (HTTP) is the protocol used in these examples to send data between different data processing systems. Of course, computer system 100 also may be implemented as a number of different types of networks such as, for example, an intranet, a local area network (LAN), or a wide area network (WAN). FIG. 1 is intended as an example, and not as an architectural limitation for the present invention.

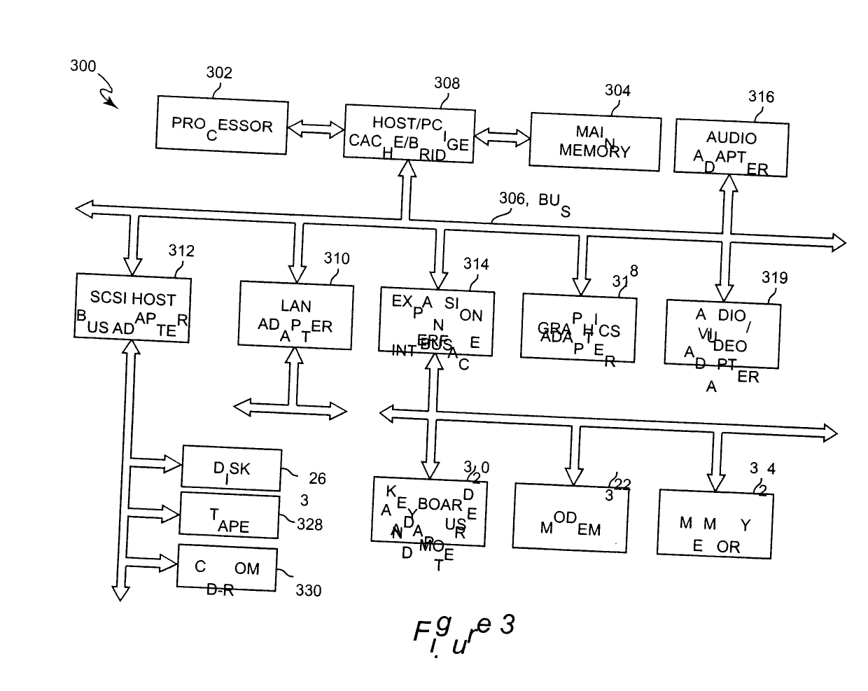

Referring to FIG. 2, a block diagram of a data processing system that may be implemented as a server, such as server 104 in FIG. 1, is depicted in accordance with a preferred embodiment of the present invention. Server 200 may be used to execute any of a variety of business processes. Server 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. Input/Output (I/O) bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108, 110 and 112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, server 200 allows connections to multiple network computers. A graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

With reference now to FIG. 3, a block diagram illustrating a client computer is depicted in accordance with a preferred embodiment of the present invention. Client computer 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards.

In the depicted example, local area network (LAN) adapter 310, Small Computer System Interface (SCSI) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object-oriented programming system such as Java may run in conjunction with the operating system and provides calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, and/or I/O devices, such as Universal Serial Bus (USB) and IEEE 1394 devices, may be used in addition to or in place of the hardware depicted in FIG. 3. Also, the processes of the present invention may be applied to a multiprocessor data processing system.

Data processing system 300 may take various forms, such as a stand alone computer or a networked computer. The depicted example in FIG. 3 and above-described examples are not meant to imply architectural limitations.

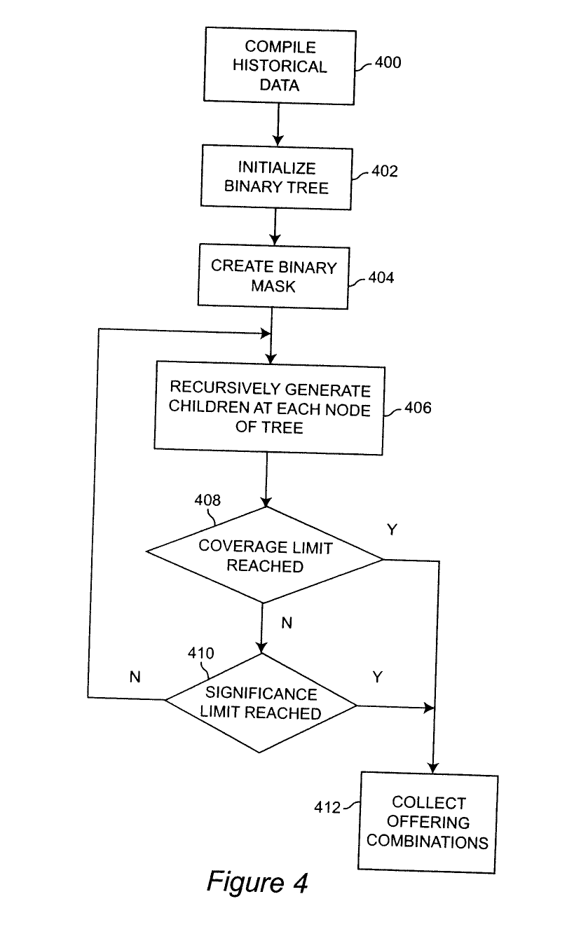

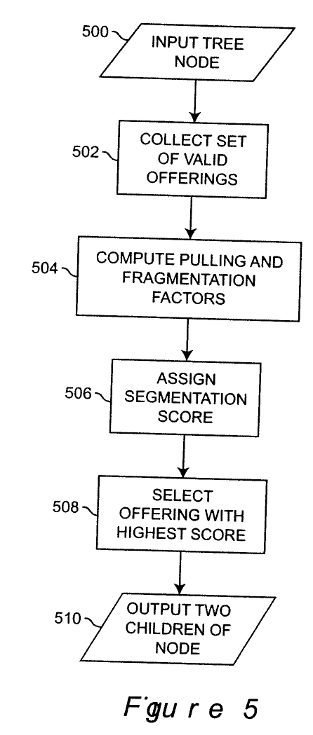

FIG. 4 shows the overall logic of the method according to the invention. The process begins function block 400 where historical data containing the revenue for each client derived from each product is compiled. Insignificant purchases (purchases with very small amount of revenue) are filtered out. In function block 402, a binary tree is initialized, and all clients and an empty offering set are assigned to the root. In function block 404, a mask is created consisting of M binary fields where M is the total number of offerings. All binary fields of the mask are set to 0 (meaning no offering has been used to segment clients).

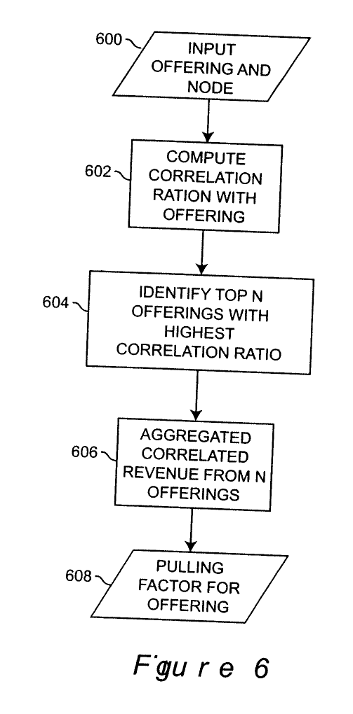

At this point in the process, a children generating procedure is recursively carried out at each node at function block 406. This process is shown in more detail in FIG. 5, to which reference is now made. The children generating procedure begins at input block 500 where a tree node is input. C represents the set of clients at this node, O represents the group of offerings purchased by the client, and M is a vector of binary values (called masking values), where a masking value of 1 indicates the corresponding offering has already been used in client segmentation, and 0 indicates otherwise. The output 510 is two children of the node, where Cl, Ol, and Ml represent the client set, offering group and mask represented by the left child, and Cr, Or, Mr represent the client set, offering group and mask represented by the right child, respectively, and the union of Cl and Cr equals C.

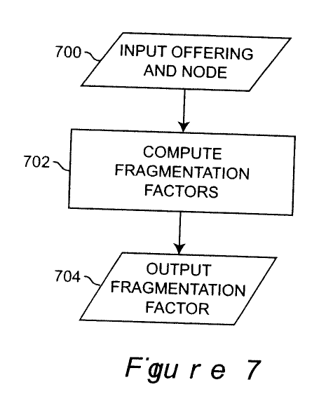

There are four steps in the process. First, at function block 502, the set of valid offerings, which are offerings whose masking values equal 0, is collected. Then for each offering, the pulling factor (P) and the fragmentation factor (F) are computed in function block 504, as explained with reference to FIGS. 6 and 7. For each offering, it's overall segmentation is assigned a score (S) to P*F in function block 506. Then, in function block 508, the offering with the highest segmentation score (S), called Os, is selected, and two children are generated such that the clients who have purchased Os are assigned to Cl and those who have not purchased offering Os are assigned to Cr. The corresponding masking value is set to 1 in Ml and Mr, and Ol and Or are updated accordingly.

FIG. 6 illustrates the process of computation of the “pulling factor” of an offering at a particular node. A higher value for “pulling factor” indicates higher correlation between this offering and its top N most correlated offerings. N is a preselected number, typically around 10% of the total number of offerings. The process begins at input block 600 where an offering and a node are input. The output 608 is the pulling factor for the given offering at the given node. The process comprises three steps. The first step at function block 602 is, for each valid offering, computing its correlation ratio with the given offering. Next, at function block 604, the top N offerings with the highest correlation ratio are identified. Then, at function block 606, the correlated revenue from these N offerings are aggregated and returned as the pulling factor for the given offering.

FIG. 7 illustrates the process of computation of the “fragmentation factor” of an offering at a particular node. A higher value of “fragmentation factor” indicates this offering is more likely to lead to fragmented nodes. The process begins at input block 700 where an offering and a node are input. The output 704 is the fragmentation factor for given offering at given node. Here, the definition of the fragmentation factor is given as alpha+pow(R, Beta), where:

alpha: shift parameter, typical value: 2

beta: slope parameter, typical value: 0.1

R: a ratio measuring how close the node is to reaching the “significance limit”, with 0 indicating the limit is reached, and 1 indicating it is far from reaching the limit.

One possible implementation of the computation in function block 702 is given as follows:

R=min{(Rev−T)/T, 1.0}, where Rev is the revenue from clients who do not purchase the given offering, and T is a threshold indicating a very small revenue.

Returning now to FIG. 4, the children generating procedure at a node is stopped if at least one of the following limits is reached:

1) Coverage limit is reached when percentage of revenue of grouped products over total revenue for clients represented by this node is larger than a preselected threshold (e.g., 80%), as determined in decision block 408, or

2) Significance limit is reached when percentage of revenue represented by the node over total revenue is less than a preselected threshold (e.g., 0.5%), as determined in decision block 410.

The last step in the process at function block 412 is to collect the offering combinations represented by all leaf nodes with significant revenue, i.e., nodes that do not reach the significance limit. The collected offering combinations are displayed, printed or otherwise output to a user. Typically, the display would be on the display of a client computer, but those skilled in the art will recognize that other outputs, including printing, are the full equivalent of a display, and the tangible output provided is useful to assist in making decisions in product offerings.

While the invention has been described in terms of a single preferred embodiment, those skilled in the art will recognize that the invention can be practiced with modification within the spirit and scope of the appended claims.

Having thus described our invention, what we claim as new and desire to secure by Letters Patent is as follows:

1. A method for determining offering combinations in a multi-product environment comprising the steps of:
analyzing multiple products or services provided by a company;
identifying offering combinations of products or services that maximize a coverage of a quantifiable business objective; and
collecting offering combinations of a quantifiable business objective.

2. The method recited in claim 1, wherein the step of identifying comprises the step of constructing a segmentation tree using a recursive algorithm to identify the offering combinations and the step of collecting the offering combinations represented by all leaf nodes of the segmentation.

3. The method recited in claim 1, wherein the step of collecting is performed using a quantifiable business objective exceeding a predetermined threshold.

4. The method recited in claim 3, wherein the quantifiable business objective is selected from the group consisting of amount of company's revenue, profit, and inventory.

5. The method recited in claim 1, further comprising the steps of:
initializing the segmentation tree as a root representing all offerings, all clients and an empty offering set; and
applying the recursive algorithm to grow the tree at each node by segmenting the clients based on whether a particular offering is purchased.

6. The method recited in claim 5, further comprising the step of selecting an offering to use for segmentation at each node based on an algorithm that considers the pulling power of the offering, where a high pulling power means that the offering is likely to produce high revenue in combination with other offerings, and fragmentation of the offering, where an low fragmentation means that the offering is unlikely to lead to fragmented nodes.

7. The method recited in claim 1, wherein the step of constructing a segmentation tree is stopped at a node if at least one of the following limits is reached:
1) Coverage limit, which is reached when percentage of revenue of grouped products over total revenue for clients represented by the node is larger than a preselected threshold, or
2) Significance limit, which is reached when percentage of revenue represented by the node over total revenue is less than a preselected threshold.

8. A computer system for determining offering combinations in a multi-product environment comprising:
a database storing information on products and services provided by a company;
a programmed processor which accesses the database and analyzes the information on products and services, said programmed processor identifying offering combinations of products or services that maximize a coverage of a quantifiable business objective; and
a display which displays offering combinations with a quantifiable business objective collected by the programmed processor.

9. The computer system recited in claim 8, wherein said programmed processor constructs a segmentation tree using a recursive algorithm to identify the offering combinations and collects the offering combinations represented by all leaf nodes of the segmentation.

10. The computer system recited in claim 8, wherein said programmed processor uses a quantifiable business objective exceeding a predetermined threshold when collecting the offering combinations.

11. The computer system recited in claim 8, wherein the programmed processor first initializes the segmentation tree as a root representing all offerings, all clients and an empty offering set, and then applies the recursive algorithm to grow the tree at each node by segmenting the clients based on whether a particular offering is purchased.

12. The computer system recited in claim 11, wherein the programmed processor selects an offering to use for segmentation at each node based on an algorithm that considers the pulling power of the offering, where a high pulling power means that the offering is likely to produce high revenue in combination with other offerings, and fragmentation of the offering, where an low fragmentation means that the offering is unlikely to lead to fragmented nodes.

13. The computer system recited in claim 1, wherein the programmed processor stops constructing a segmentation tree at a node if at least one of the following limits is reached:
1) coverage limit, which is reached when percentage of revenue of grouped products over total revenue for clients represented by the node is larger than a preselected threshold, or
2) significance limit, which is reached when percentage of revenue represented by the node over total revenue is less than a preselected threshold.

14. A computer readable medium having computer code for performing a process on a computer for determining offering combinations in a multi-product environment, the process comprising the steps of:
analyzing multiple products or services provided by a company;
identifying offering combinations of products or services that maximize a coverage of a quantifiable business objective; and
collecting offering combinations of a quantifiable business objective.

15. The computer readable medium recited in claim 14, wherein the step of identifying comprises the step of constructing a segmentation tree using a recursive algorithm to identify the offering combinations and the step of collecting collects the offering combinations represented by all leaf nodes of the segmentation.

16. The computer readable medium recited in claim 14, wherein the step of collecting is performed using a quantifiable business objective exceeding a predetermined threshold.

17. The computer readable medium recited in claim 14, wherein in the process performed by the computer code further comprises the steps of:
initializing the segmentation tree as a root representing all offerings, all clients and an empty offering set; and
applying the recursive algorithm to grow the tree at each node by segmenting the clients based on whether a particular offering is purchased.

18. The computer readable medium recited in claim 17, wherein the process performed by the code further comprises the step of selecting an offering to use for segmentation at each node based on an algorithm that considers the pulling power of the offering, where a high pulling power means that the offering is likely to produce high revenue in combination with other offerings, and fragmentation of the offering, where an low fragmentation means that the offering is unlikely to lead to fragmented nodes.

19. The computer readable medium recited in claim 14, wherein the step of constructing a segmentation tree is stopped at a node if at least one of the following limits is reached:
1) coverage limit, which is reached when percentage of revenue of grouped products over total revenue for clients represented by the node is larger than a preselected threshold, or
2) significance limit, which is reached when percentage of revenue represented by the node over total revenue is less than a preselected threshold.
